(19) United States
(12) Patent Application Publication
(10) Pub. No.: US 2014/0212701 A1
(43) Pub. Date: Jul. 31, 2014

(54) BATTERY CELL

(71) Applicant: Samsung SDI Co., Ltd., Yongin-si (KR)

(72) Inventor: Sang-Do Hur, Yongin-si (KR)

(73) Assignee: Samsung SDI Co., Ltd., Yongin-si (KR)

(21) Appl. No.: 14/067,680

(22) Filed: Oct. 30, 2013

Related U.S. Application Data
(60) Provisional application No. 61/758,182, filed on Jan. 29, 2013.

(51) Int. Cl. H01M 2/34

(52) U.S. Cl. CPC H01M 2/348
USPC 429/7

(57) ABSTRACT

A battery cell including an electrode assembly, a case and a protection element is disclosed. The electrode assembly is electrically coupled to electrode tabs. The case houses the electrode assembly and includes a sealing portion formed at an edge thereof and a mounting portion at the sealing portion and housing a protection element electrically coupled to one of the electrode tabs.

### CROSS-REFERENCE TO RELATED APPLICATION

This application claims priority to and the benefit of U.S. Provisional Application No. 61/758,182, filed on Jan. 29, 2013 in the U.S. Patent and Trademark Office, the entire content of which is incorporated herein by reference.

### BACKGROUND

1. Field

An aspect of embodiments according to the present invention relates to a battery pack (e.g., a battery cell).

2. Description of the Related Art

Recently, various secondary batteries have been used as power sources for portable electronic devices. As portable electronic devices are used in various fields, demands on certain secondary batteries have rapidly increased. Secondary batteries can be charged/discharged a plurality of times, and accordingly are economically and environmentally efficient. Thus, the use of the secondary battery packs is encouraged.

As electronic devices become smaller in size and lighter in weight, so too should secondary batteries become smaller in size and lighter in weight. However, because secondary batteries include materials having high reactivity, such as lithium, the small size and light weight of a secondary battery is limited due to safety issues relating to the secondary battery. Accordingly, a variety of studies have been conducted to develop a battery cell that can be implemented as a small and light battery cell while also improving the safety of the secondary battery.

### SUMMARY

Aspects of embodiments of the present invention provide a battery cell having improved safety while being small in size and light in weight by employing a novel structure.

According to an embodiment of the present invention, a battery cell includes: an electrode assembly electrically coupled to electrode tabs; and a case housing the electrode assembly, the case including: a sealing portion at an edge of the case; and a mounting portion at the sealing portion and housing a protection element electrically coupled to one of the electrode tabs.

The mounting portion having the protection element mounted therein may be formed in the sealing portion.

The mounting portion may be sealed. For example, surroundings of the mounting portion may be sealed hermetically by the sealing portion.

An outer surface of the mounting portion may protrude (e.g., may be formed to protrude) in the outer direction of the case.

The mounting portion may be concave (e.g., concavely formed) so that an inner surface of the mounting portion accommodates the protection element.

The electrode tabs may include a first electrode tab and a second electrode tab. The first electrode tab may be connected to (e.g., electrically coupled to) the protection element. The second electrode tab may be extracted to the outside of the battery cell through the sealing portion. For example, the second electrode tab may extend through the sealing portion to the outside of the battery cell.

The protection element may include a first connection portion and a second connection portion. The first connection portion may be connected to (e.g., electrically coupled to) the first electrode tab. The second connection portion may be extracted to the outside of the battery cell through the sealing portion. For example, the second connection portion may extend through the sealing portion to the outside of the battery cell.

The case may include a first subcase and a second subcase. The first and second subcases may be coupled to each other by the sealing portion.

The first subcase and the second subcase may each include an inner resin layer, and the sealing portion may include a portion of the inner resin layer of the first subcase and a portion of the inner resin layer of the second subcase coupled to one another. The sealing portion may be formed by thermal fusion of a first edge portion of the first subcase and a second edge portion of the second subcase. For example, the portion of the inner resin layer of the first subcase and the portion of the inner resin layer of the second subcase may be thermally fused to form the sealing portion.

One of the first subcase and the second subcase may include an accommodating portion for accommodating the electrode assembly, and the other of the first subcase and the second subcase covers the accommodating portion. For example, the accommodating portion for accommodating the electrode assembly therein may be formed in the first subcase, and the second subcase may cover the first subcase.

The outer surfaces of the mounting portion and the accommodating portion may be protruded in the same direction.

The sealing portion may include a first surface from which an outer surface of the mounting portion protrudes and a second surface opposite to the first surface, and a portion of the sealing portion may be bent such that the first surface faces the accommodating portion. For example, the sealing portion may include one surface from which the outer surface of the mounting portion is protruded, and the other surface opposite to the one surface, and the sealing portion may be bent so that the other surface faces the accommodating portion. In some embodiments, the sealing portion is bent such that the second surface faces the accommodating portion.

The sealing portion may be bent so that the outer surface of the mounting portion faces the outside of the case.

In some embodiments, one of the first subcase and the second subcase includes an accommodating portion for accommodating the electrode assembly, and the mounting portion is at the other of the first subcase and the second subcase.

In some embodiments, one of the first subcase and that second subcase includes both the mounting portion and the accommodating portion for accommodating the electrode assembly.

The sealing portion may seal the mounting portion from the accommodating portion. For example, the mounting portion and the accommodating portion may be divided by the sealing portion so as to be individually sealed hermitically.

The inner surface of the sealing portion by which the first and second subcases are coupled to each other may include casting (e.g., cast) polypropylene (CPP).

The first subcase may include a first accommodating portion for partially accommodating the electrode assembly and the second subcase may include a second accommodating portion for partially accommodating the electrode assembly. For example, a first accommodating portion accommodating one side of the electrode assembly therein may be formed in the first subcase, and a second accommodating portion accommodating the other side of the electrode assembly therein may be in the second subcase.

The electrode tab may be provided with an electrode tab film mounted on the sealing portion. For example, one of the electrode tabs or the protection element may include a resin coupled to the sealing portion.

The second connection portion of the protection element may be provided with a connection portion film mounted on the sealing portion.

In some embodiments, the mounting portion is embedded in the sealing portion.

Other features and aspects of the present invention will become more fully apparent from the following detailed description, taken in conjunction with the accompanying drawings.

Terms or words used in this specification and claims should not necessarily be restrictively interpreted only by their ordinary meanings or dictionary-based meanings, but should be interpreted according to meanings and concepts conforming to the scope of the present invention on the basis of the principle that an inventor can act as his or her own lexicographer and define the concept of a term to describe and explain his or her invention in the clearest or best way.

According to aspects of embodiments of the battery cell of the present invention, a protection element is positioned in a case, so that it is possible to improve the safety of the battery cell while implementing the miniaturization of the battery cell.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a battery cell according to an embodiment of the present invention.

FIG. 2 is an exploded perspective view of the embodiment of the battery cell shown in FIG. 1.

FIG. 3 is a cross-sectional view of the embodiment of the battery cell of FIG. 1 taken along the line A-A′.

FIG. 4 is a perspective view of a battery cell according to another embodiment of the present invention.

FIG. 5 is an exploded perspective view of the embodiment of the battery cell shown in FIG. 4.

FIG. 6 is a perspective view of the embodiment of the battery cell shown in FIG. 4, in which a sealing portion is bent.

FIG. 7 is a perspective view of a battery cell according to still another embodiment of the present invention.

FIG. 8 is an exploded perspective view of the embodiment of the battery cell shown in FIG. 7.

FIG. 9 is a perspective view of the embodiment of the battery cell shown in FIG. 7, in which a portion of a sealing portion is bent.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

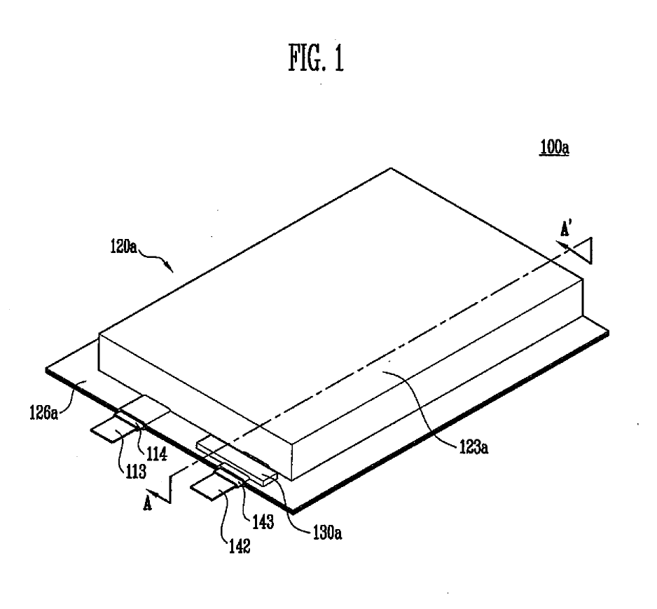

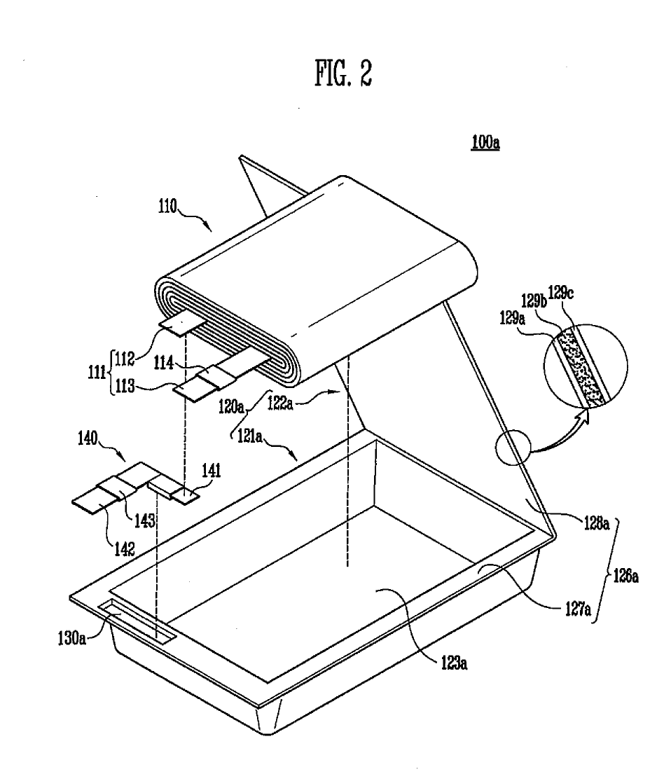

FIG. 1 is a perspective view of a battery cell 100a according to an embodiment of the present invention. FIG. 2 is an exploded perspective view of the battery cell 100a shown in FIG. 1. For convenience of illustration, FIG. 2 is an exploded perspective view showing a state in which the battery cell 100a shown in FIG. 1 is turned (or flipped) over. Hereinafter, the battery cell 100a according to this embodiment will be described with reference to FIGS. 1 and 2.

As shown in FIGS. 1 and 2, the battery cell 100a according to this embodiment may include an electrode assembly 110 electrically coupled to electrode tabs 111, and a case 120a accommodating (e.g., housing) the electrode assembly 110. The case 120a includes a sealing portion 126a formed at an edge of the case, and a protection element 140 connected to (e.g., electrically coupled to) one of the electrode tabs 111 and positioned in the case 120a (e.g., housed by a mounting portion at the sealing portion 126a).

The electrode assembly 110 is a member having the electrode tabs 111 at one side thereof. The electrode assembly 110 forms, together with the case 120a, the battery cell 100a or a bare cell configured to generate electrochemical energy through the movement of ions or electrons.

Here, the electrode assembly 110 may include a first electrode plate, a second electrode plate, a separator interposed between the first and second electrode plates, and the electrode tabs 111 may include first and second electrode tabs 112 and 113 extracted to (e.g., extending to) the outside of the electrode assembly 110. In this embodiment, the first and second electrode plates may include positive and negative electrode plates, respectively, and the first and second electrode tabs 112 and 113 may be positive and negative electrode tabs, respectively. The electrode tabs 111 may be extracted from the one side of the electrode assembly 110 so as to provide the outside of the electrode assembly 110 or the protection element 140 with the electrochemical energy generated inside the battery cell 100a. The electrode assembly 110 may be manufactured by various methods of winding or stacking the first electrode plate, the second electrode plate and the separator, etc. In embodiments according to the present invention, it will be apparent that the electrode assembly 110 may include all suitable types of electrode assemblies such as, for example, a stacking type electrode assembly (e.g., a stacked electrode assembly) and a winding type electrode assembly (e.g., a wound electrode assembly).

The case 120a is a member that accommodates (e.g., houses) the electrode assembly 110 therein. The case 120a may include a first subcase 121a and a second subcase 122a.

Here, in this embodiment, a mounting portion 130a accommodating (e.g., housing) the protection element 140 therein and an accommodating portion 123a accommodating (e.g., housing) the electrode assembly 110 therein are formed in the first subcase 121a, and the second subcase 122a covers (e.g., is implemented to cover) the first subcase 121a. Therefore, the mounting portion 130a of the first subcase 121a may correspond to the shape and size of the protection element 140, and the accommodating portion 123a of the first subcase 121a may correspond to the shape and size of the electrode assembly 110 (or a portion of the electrode assembly 110). For example, the mounting portion 130a and the accommodating portion 123a may be manufactured through a deep drawing process of making a hollow container without any joint, using a flat plate (e.g., a process in which a pressure is applied using a flat plate to create a recess or container in a material to which the pressure is applied).

The first and second subcases 121a and 122a may be coupled to each other by the sealing portion 126a formed at the edge of the case 120a. For example, the protection element 140 is accommodated in (e.g., housed by) the mounting portion 130a at a first edge portion 127a of the first subcase 121a, and the electrode assembly 110 and an electrolyte are accommodated in the accommodating portion 123a of the first subcase 121a. Then, the first edge portion 127a of the first subcase 121a and a second edge portion 128a of the second subcase 122a are thermally fused to each other in a state in which the first and second subcases 121a and 122a are adhered closely to each other, thereby forming the sealing portion 126a. Accordingly, the battery cell 100a can be manufactured. For example, in this embodiment, the battery cell 100a may be implemented as a pouch-type or polymer-type battery cell.

Meanwhile, as shown in the inset of FIG. 2, the case 120a may sequentially include an inner resin layer 129a, a metal layer 129b and an outer resin layer 129c. In this case, the inner resin layer 129a is a portion directly facing the electrode assembly 110, and the outer resin layer 129c is a portion corresponding to the outermost surface of the case 120a. The inner and outer resin layers 129a and 129c may be made of a polymer resin or the like, which is an electrical nonconductor (e.g., electrically insulating), so as to prevent (or reduce the likelihood of) a short circuit therebetween. A portion of the inner resin layer 129a may form the sealing portion 126 (e.g., 126a) to couple the first and second subcases 121a and 122a to each other. For example, the inner and outer resin layers 129a and 129c may include casting (e.g., cast) polypropylene (CPP). The metal layer 129b is provided between the inner and outer resin layers 129a and 129c so as to provide the case 120a with a predetermined (or set) mechanical strength. For example, the metal layer 129b may include aluminum, and the like.

When the electrode tabs 111 contact the metal layer 129b exposed at an end of the sealing portion 126 (e.g., 126a), there may occur an electrical short circuit between the electrode tabs 111 and the metal layer 129b. In order to prevent (or reduce the likelihood of) the electrical short circuit, one or more of the electrode tabs 111 according to this embodiment may be further provided with an electrode tab film 114. Here, in this embodiment, the electrode tab film 114 may be mounted on the sealing portion 126a, and may be made of an electrical nonconductor (e.g., an electrical insulator), thereby preventing (or reducing the likelihood of) the short circuit between the electrode tabs 111 and the metal layer 129b. The electrode tab film 114 is made of a material similar to the sealing portion 126 (e.g., 126a) so that the sealing portion 126a can be thermally fused (e.g., completely thermally fused). Accordingly, the electrode tab made of metal can be adhered (e.g., completely adhered) closely to the sealing portion 126a. As a result, the sealing performance of the case 120a can be reinforced (e.g., improved) by the electrode tab film 114. In this embodiment, the second electrode tab 113 of the electrode assembly 110 is extracted to the outside through the sealing portion 126a (e.g., the second electrode tab 113 extends through the sealing portion 126a to the outside of the battery cell), and the first electrode tab 112 of the electrode assembly 110 is connected to the protection element 140 positioned in the mounting portion 130a of the sealing portion 126a so as not to be exposed to the outside of the battery cell. Therefore, the electrode tab film 114 may be provided to (e.g., on) the second electrode tab 113.

Meanwhile, the mounting portion 130a of the battery cell 100a according to this embodiment may be at (e.g., formed in) the sealing portion 126a of the case 120a. For example, in this embodiment, the mounting portion 130a may be at (e.g., formed at) the first edge portion 127a of the first subcase 121a, and an outer surface of the mounting portion 130a may protrude (e.g., be formed to protrude) outward in the same (or substantially the same) direction as an outer surface of the accommodating portion 123a. In this embodiment, both the mounting portion 130a and the accommodating portion 123a are protruded in the same (or substantially the same) direction, which may provide space efficiency. When being viewed from the inside of the case 120a, the mounting portion 130a may be concave (e.g., concavely formed) so that an inner surface of the mounting portion 130a can accommodate the protection element 140, and the protection element 140 can be mounted in the concave space. In some embodiments, the mounting portion 130a is embedded in the sealing portion 126a.

The protection element 140 is a member that is connected (e.g., electrically coupled) between the electrode assembly 110 and a protective circuit module so as to cut off current when abnormal (e.g., excess) current flows in the battery cell 100a. The protection element 140 may be mounted (e.g., housed) in the mounting portion 130a.

Here, the protection element 140 may be implemented as, for example, a positive temperature coefficient (PTC) element, fuse, breaker, or the like. If abnormal (e.g., excess) current flows in the battery cell 100a, the resistance of the protection element 140 increases so as to cut off current flowing through first and second connection portions 141 and 142 of the protection element 140. The first connection portion 141 may be connected (e.g., electrically coupled) to the first electrode tab 112, and the second connection portion 142 may be extracted to the outside of the battery cell 100a through the sealing portion 126a (e.g., the second connection portion 142 may extend through the sealing portion 126a to the outside of the battery cell 100a). Thus, when being viewed from the outside of the battery cell 100a, it can be seen that the second connection portion 142 of the protection element 140 and the second electrode tab 113 are exposed. In this embodiment, the second connection portion 142 is extracted to the outside through the sealing portion 126a, and hence the protection element 140 may be further provided with a connection portion film 143 so that the metal layer 129b at the end of the sealing portion 126a is not short-circuited with the second connection portion 142. The connection portion 143 is made of a material similar to the sealing portion 126a so that the second connection portion 142 and the sealing portion 126 can be thermally fused (e.g., completely thermally fused).

FIG. 3 is a cross-sectional view of the battery cell 100a taken along the line A-A′ of FIG. 1. Hereinafter, the mounting portion 130a according to this embodiment will be described in more detail with reference to FIG. 3.

Here, in this embodiment, the protection element 140 may be positioned in the case 120a. For example, the mounting portion 130a may be at (e.g., formed in) the sealing portion 126a. In this embodiment, the protection element 140 having a relatively small size is positioned in the concave space inside the mounting portion 130a, and hence the size of the internal space of the mounting portion 130a may be smaller than that of the accommodating portion 123a in which the electrode assembly 110 is positioned. The mounting portion 130a may be sealed. For example, the mounting portion 130a and the accommodating portion 123a may be divided by the sealing portion 126a so as to be individually sealed hermitically. Thus, there is less concern (or no concern) that electrolyte positioned in the accommodating portion 123a contacts the protection element 140 positioned in the mounting portion 130a. Accordingly, the safety of the battery cell 100a can be improved. When the protection element 140 positioned in the mounting portion 130a is exposed to the outside, there is a concern that the protection element 140 may be damaged or undesirably short-circuited. Hence, surroundings of the mounting portion 130a may all be sealed (e.g., hermetically sealed) by the sealing portion 126a.

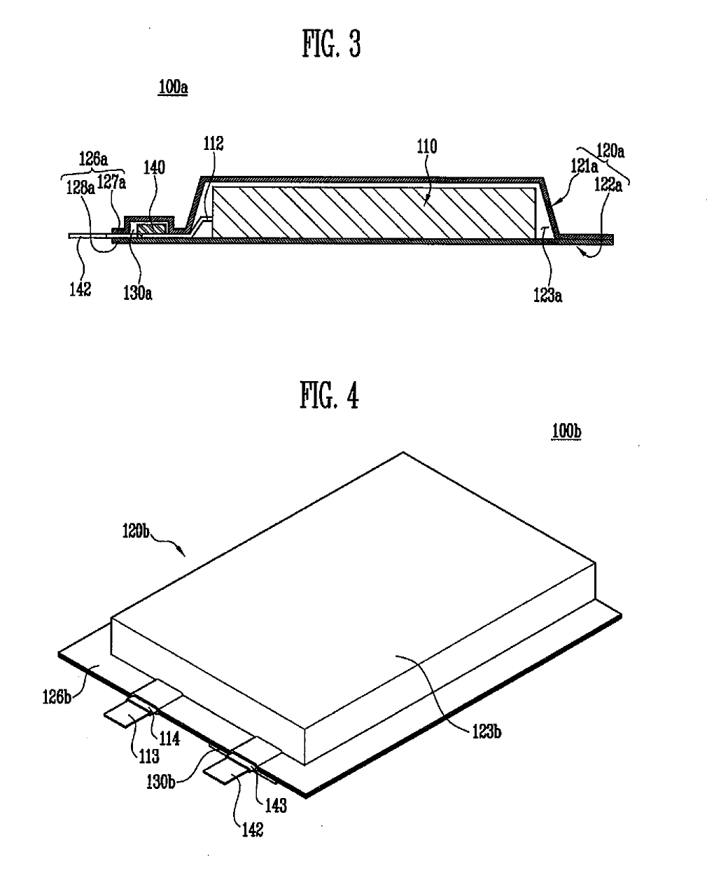

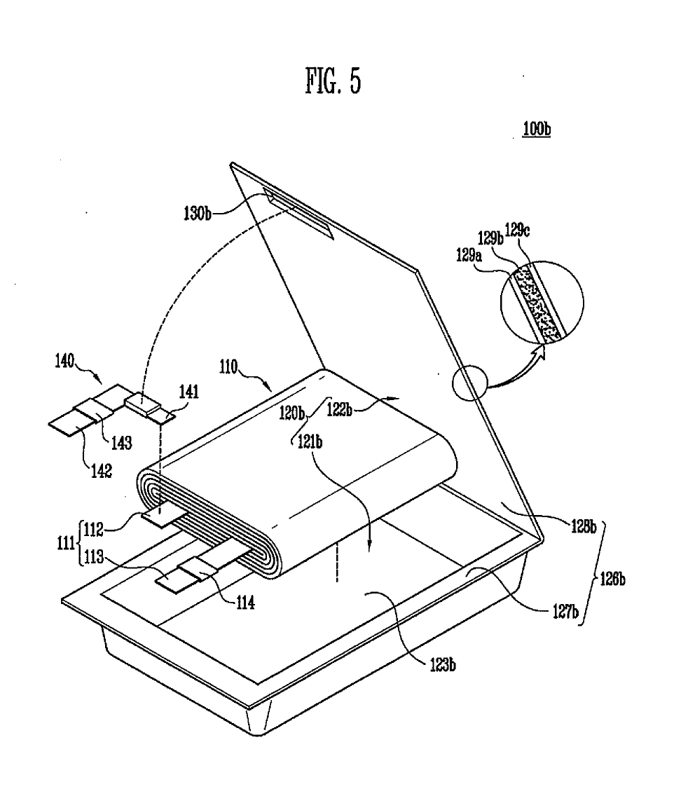

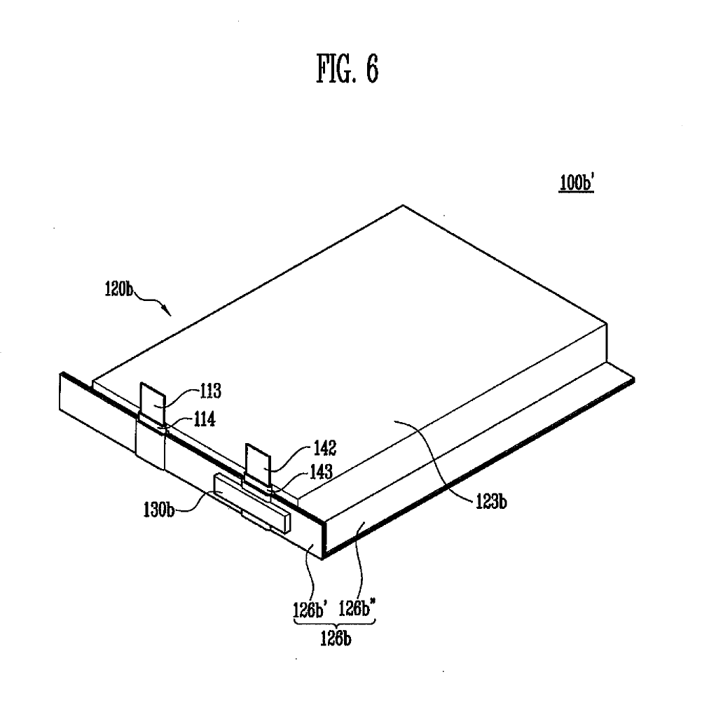

FIG. 4 is a perspective view of a battery cell 100b according to another embodiment of the present invention. FIG. 5 is an exploded perspective view of the embodiment of the battery cell 100b shown in FIG. 4. FIG. 6 is a perspective view of the embodiment of the battery cell 100b shown in FIG. 4, in which a sealing portion 126b is bent (e.g., a portion of the sealing portion 126b is bent). For convenience of illustration, FIG. 5 is an exploded perspective view showing a state in which the battery cell 100b shown in FIG. 4 is turned (e.g., flipped) over. Hereinafter, the battery cell 100b and 100b′ according to this embodiment will be described with reference to FIGS. 4, 5 and 6. Here, components identical, substantially identical or corresponding to those of the aforementioned embodiment are designated by like reference numerals, and their detailed descriptions will be omitted here to avoid redundancy.

For example, as shown in FIGS. 4 and 5, in the battery cell 100b according to this embodiment, protruding directions of a mounting portion 130b and an outer surface of an accommodating portion 123b may be opposite to each other before the sealing portion 126b is bent, e.g., in a state in which the sealing portion 126b is unfolded (e.g., flat). The mounting portion 130b may protrude (e.g., be formed to protrude) from a second edge portion 128b of a second subcase 122b, which constitutes, together with a first edge portion 127b of a first subcase 121b, the sealing portion 126, such that the mounting portion 130b protrudes in a direction opposite to the direction in which the accommodating portion 123b protrudes from the first subcase 121b.

In embodiments in which the mounting portion 130b and the outer surface of the accommodating portion 123b protrude in opposite directions, space efficiency of the battery cell may be decreased. Therefore, the space of the battery cell 100b may be efficiently used (e.g., space efficiency may be increased) by bending the sealing portion 126b to the position shown in FIG. 6. For example, the sealing portion 126b may be bent so that the other surface opposite to the one surface of both surfaces of the sealing portion 126b, from which the outer surface of the mounting portion 130b is protruded, faces the accommodating portion 123b. In other words, the sealing portion 126b can include a first surface from which an outer surface of the mounting portion protrudes and a second surface opposite to the first surface, and the sealing portion 126b (or a portion thereof) can be bent such that the second surface faces the accommodating portion 123b. Thus, the sealing portion 126b (or a portion thereof) may be bent so that the protruded outer surface of the mounting portion 130b faces the outside of a case 120b. Accordingly, the effective space of the battery cell 100b can be expanded (e.g., increased).

In other embodiments, the sealing portion (or a portion thereof) may be bent such that the mounting portion faces toward the accommodating portion. In other words, the sealing portion 126b can include a first surface from which an outer surface of the mounting portion 130b protrudes and a second surface opposite to the first surface, and the sealing portion 126b (or a portion thereof) can be bent such that the first surface faces the accommodating portion 123b.

Meanwhile, the sealing portion 126b may include a first sealing portion 126b′ in the extracting direction of the second electrode tab 113 and the second connection portion 142 (e.g., at a side at which the second electrode tab 113 and the second connection portion 142 extend through the sealing portion 126b), and second sealing portions 126b″ respectively extended from both ends of the first sealing portion 126b′. In addition to the first sealing portion 126b′, the second sealing portion 126b″ may also be bent to face the accommodating portion 123b, thereby further improving space efficiency. A third sealing portion may also be provided on a surface opposite to the first sealing portion 126b′.

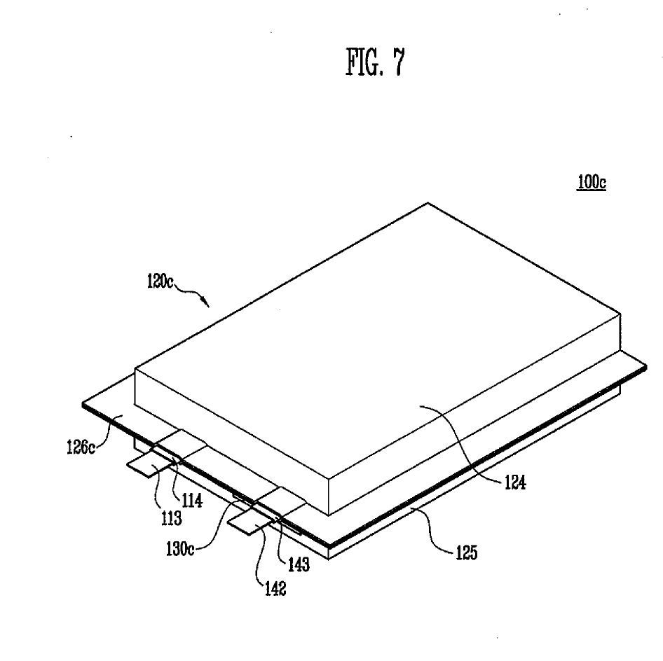

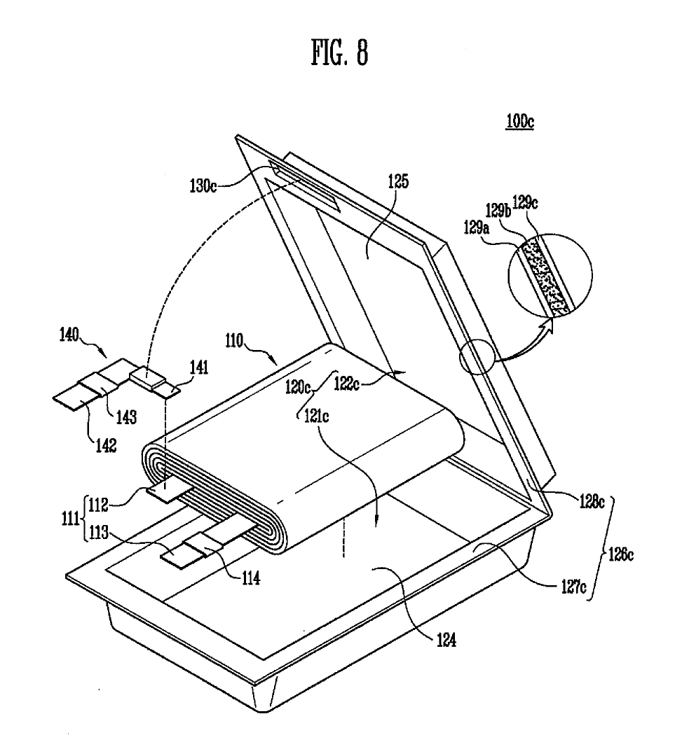

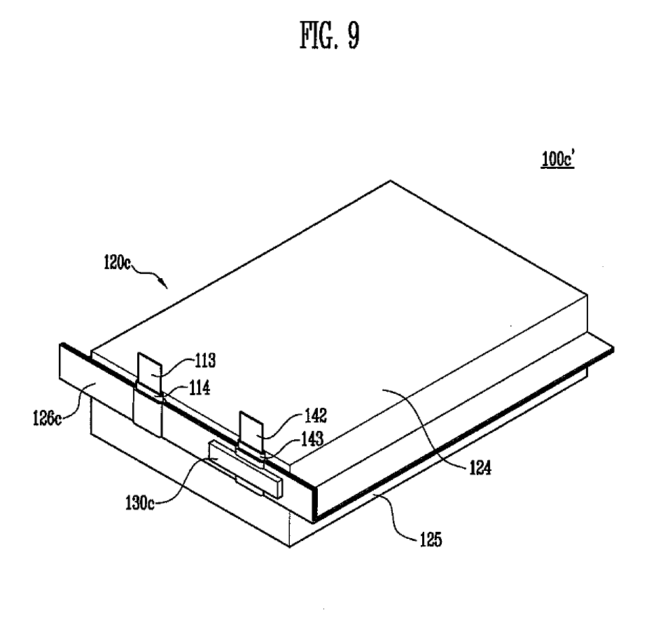

FIG. 7 is a perspective view of a battery cell 100c according to still another embodiment of the present invention. FIG. 8 is an exploded perspective view of the battery cell 100c shown in FIG. 7. FIG. 9 is a perspective view of the battery cell 100c shown in FIG. 7, in which sealing portion 126c is bent. For convenience of illustration, FIG. 8 is an exploded perspective view showing a state in which the battery cell 100c shown in FIG. 7 is turned (e.g., flipped) over. Hereinafter, the battery cell 100c and 100c′ according to this embodiment will be described with reference to FIGS. 7, 8 and 9. Here, components identical, substantially identical, or corresponding to those of the aforementioned embodiments are designated by like reference numerals, and their detailed descriptions will be omitted here to avoid redundancy.

As shown in FIGS. 7 and 8, the battery cell 100c according to this embodiment includes the electrode assembly 110, a case 120c and the protection element 140. A first accommodating portion 124 may be formed in a first subcase 121c, and a second accommodating portion 125 may be formed in a second subcase 122c.

For example, in the battery cell 100c according to this embodiment, the accommodating portion may be configured with the first accommodating portion 124 of the first subcase 121c and the second accommodating portion 125 of the second subcase 122c. The first and second accommodating portions 124 and 125 may accommodate one and the other sides of the electrode assembly 110, respectively. For example, the first subcase 121c may include the first accommodating portion 124 for partially accommodating the electrode assembly 110, and the second subcase 122c may include a second accommodating portion 125 for partially accommodating the electrode assembly 110. Meanwhile, a mounting portion 130c having the protection element 140 mounted therein may be at (e.g., formed in) the sealing portion 126c or an edge portion 127c or 128c, corresponding to any one of the first and second subcases 121c and 122c. In some embodiments, the mounting portion 130c is embedded in the sealing portion 126c.

As shown in FIG. 9, in the battery cell 100c′, the sealing portion 126c may be bent to improve space efficiency. In this embodiment, the sealing portion 126c may be bent so that the other surface opposite to one surface of the sealing portion 126c, from which the outer surface of the mounting portion 130c is protruded, faces the first or second accommodating portions 124 or 125, so that the outer surface of the mounting portion 130c is protruded toward the outside of the case 120c.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery cell comprising:
an electrode assembly electrically coupled to electrode tabs; and
a case housing the electrode assembly, the case comprising:
a sealing portion at an edge of the case; and
a mounting portion at the sealing portion, and housing a protection element electrically coupled to one of the electrode tabs.

2. The battery cell of claim 1, wherein the electrode tabs comprise a first electrode tab and a second electrode tab, and the protection element is electrically coupled to the first electrode tab.

3. The battery cell of claim 2, wherein the second electrode tab extends through the sealing portion to the outside of the battery cell.

4. The battery cell of claim 1, wherein the mounting portion is sealed.

5. The battery cell of claim 1, wherein the protection element comprises a first connection portion and a second connection portion.

6. The battery cell of claim 5, wherein one of the electrode tabs is a first electrode tab, and the first connection portion is electrically coupled to the first electrode tab.

7. The battery cell of claim 5, wherein the second connection portion extends through the sealing portion to the outside of the battery cell.

8. The battery cell of claim 1, wherein the case comprises a first subcase and a second subcase.

9. The battery cell of claim 8, wherein the first subcase is coupled to the second subcase by the sealing portion.

10. The battery cell of claim 8, wherein the first subcase and the second subcase each include an inner resin layer, and the sealing portion comprises a portion of the inner resin layer of the first subcase and a portion of the inner resin layer of the second subcase coupled to one another.

11. The battery cell of claim 10, wherein the portion of the inner resin layer of the first subcase and the portion of the inner resin layer of the second subcase are thermally fused to form the sealing portion.

12. The battery cell of claim 8, wherein one of the first subcase and the second subcase comprises an accommodating portion for accommodating the electrode assembly, and the other of the first subcase and the second subcase covers the accommodating portion.

13. The battery cell of claim 12, wherein the sealing portion seals the mounting portion from the accommodating portion.

14. The battery cell of claim 12, wherein the sealing portion comprises a first surface from which an outer surface of the mounting portion protrudes and a second surface opposite to the first surface, and wherein a portion of the sealing portion is bent such that the first surface faces the accommodating portion.

15. The battery cell of claim 12, wherein the sealing portion comprises a first surface from which an outer surface of the mounting portion protrudes and a second surface opposite to the first surface, and wherein a portion of the sealing portion is bent such that the second surface faces the accommodating portion.

16. The battery cell of claim 8, wherein one of the first subcase and the second subcase comprises an accommodating portion for accommodating the electrode assembly, and the mounting portion is at the other of the first subcase and the second subcase.

17. The battery cell of claim 8, wherein one of the first subcase and the second subcase comprises the mounting portion and an accommodating portion for accommodating the electrode assembly.

18. The battery cell of claim 8, wherein the first subcase comprises a first accommodating portion for partially accommodating the electrode assembly and the second subcase comprises a second accommodating portion for partially accommodating the electrode assembly.

19. The battery cell of claim 1, wherein one of the electrode tabs or the protection element comprises a resin coupled to the sealing portion.

20. The battery cell of claim 1, wherein the mounting portion is embedded in the sealing portion.
